(19) United States
(12) Patent Application Publication
(10) Pub. No.: US 2009/0017701 A1
(43) Pub. Date: Jan. 15, 2009

(54) Battery connector

(75) Inventor: Zhong-Jun Ma, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/218,411

(22) Filed: Jul. 14, 2008

(30) Foreign Application Priority Data
Jul. 12, 2007 (CN) 200720040744.1

(51) Int. Cl. H01R 13/514

(52) U.S. Cl. 439/752

(57) ABSTRACT

A battery connector comprising: an insulative housing; a plurality of contacts received in the insulative housing; wherein the battery connector further including a block portion to prevent the contacts from dropping out of the insulative housing. The block portion can be used to reduce the moving extent of the contacts, increase the compactedness between of the contacts and the insulative housing.

### BACKGROUND OF THE INVENTION

1. Field of the Invention

The present invention relates to a battery connector, more particularly to a battery connector for handset or portable electrical device.

2. Description of Prior Arts

In normal electronic devices, such as a cell phone, usually uses a battery connector to provide an electrical connection between one of the electronic devices and a battery.

The FIG. 1 discloses a conventional battery connector 100′, comprising an insulative housing 1′, a plurality of contacts 2′ and a metal cover 3′. The metal cover 3′ includes a main portion (not marked), side wings which bending and extending forward from two sides of the main portion, and fix portion 33′ which bending and extending outward from the side wings 32′; the insulative housing including a top wall 11′, a front wall 12′, a first sidewall 13′ and a second sidewall 14′, a sunken portion 111′ is formed which is corresponding to the main portion and the side wings 32′ of the insulative housing 1′. Installing the metal cover 3′ in the sunken portion 111′, the retention between the battery connector 100′ and the printed circuit board can be strengthened by soldering of the fix portion 33′ and the printed circuit board. However, after installing the contacts 2′ in the insulative housing 1′, there is no element attached to the front wall 12′ can be used to block the contact 2′. Therefore, it will be easy for the contact 2′ to drop off the insulative housing 1′

Hence, an improved battery connector is desired to overcome the disadvantages and problems of the prior art.

### SUMMARY OF THE INVENTION

Accordingly, it is an object of the present invention to provide a battery connector in order to increase the structure.

In order to achieve the above mentioned objects, a battery connector in accordance with a preferred embodiment of the present invention comprising: an insulative housing; a plurality of contacts received in the insulative housing; wherein the battery connector further including a block portion to prevent the contacts from dropping out of the insulative housing. The block portion can be used to reduce the moving extent of the contacts, increase the compactedness between of the contacts and the insulative housing.

Other objects, advantages and novel features of the invention will become more apparent from the following detailed description of the present embodiment when taken in conjunction with the accompanying drawings.

### BRIEF DESCRIPTION OF THE DRAWING

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an assembled perspective view of the prior art;

FIG. 2 is an exploded view of a battery connector of the present invention;

FIG. 3 is a stereoscopic view of the insulative housing of the battery connector shown in FIG. 2;

FIG. 4 is a stereoscopic view of the block of the battery connector shown in FIG. 2; and

FIG. 5 is an assembled perspective view of the battery connector shown in FIG. 2.

### DETAILED DESCRIPTION OF THE INVENTION

While the invention may be embodied in different forms, there is shown in the drawings, and herein will be described in detail, specific embodiments with the understanding that the present disclosure is to be considered an exemplification of the principles of the invention, and is not intended to limit the invention to that as illustrated and described herein.

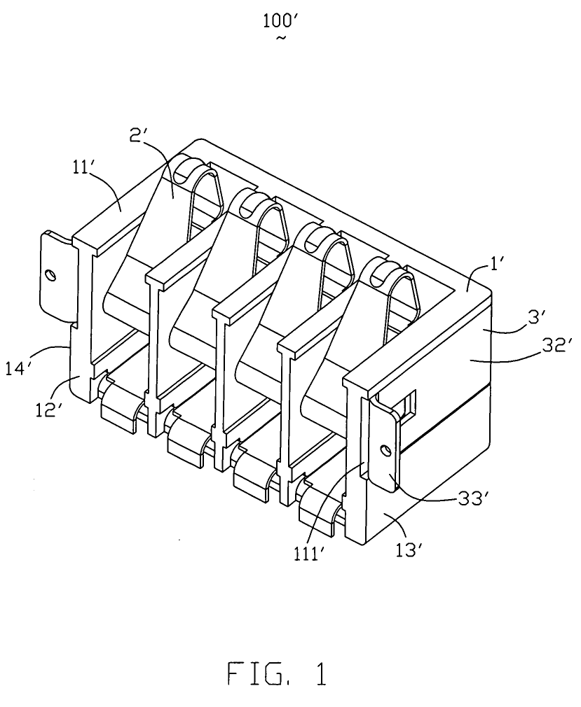

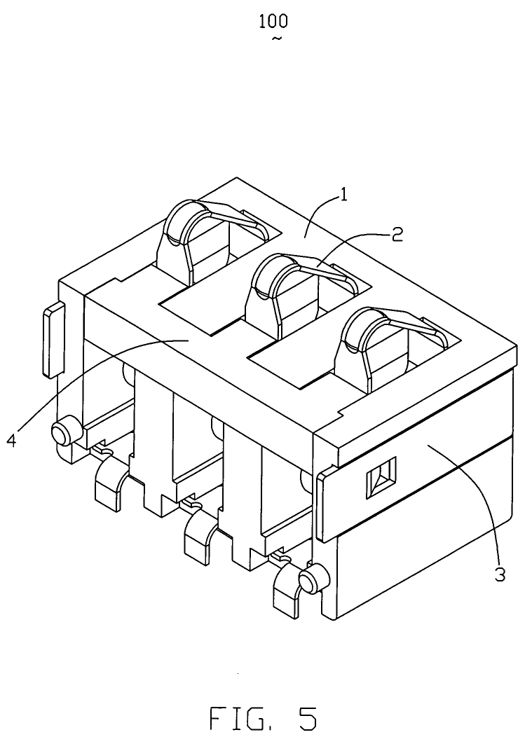

Referring to the FIG. 1 to FIG. 5, the present invention provides a battery connector 100 assembling to a printed circuit board of a cell phone for electrically mating to a corresponding joint, electrically connecting to a battery in the cell phone. The battery connector 100 includes an insulative housing 1, a plurality of contacts 2 received in the insulative housing 1, a metal cover 3 and a block portion 4 attached to the insulative housing 1.

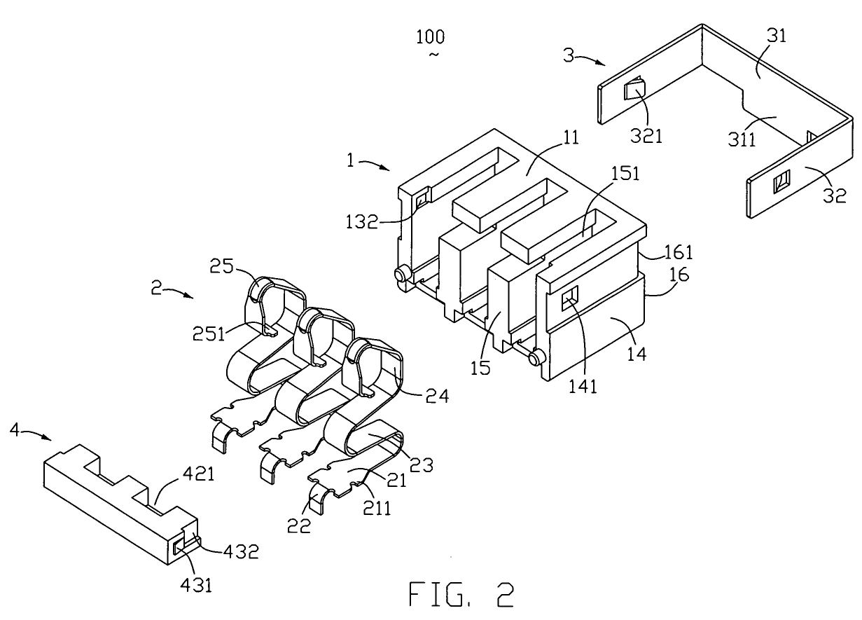

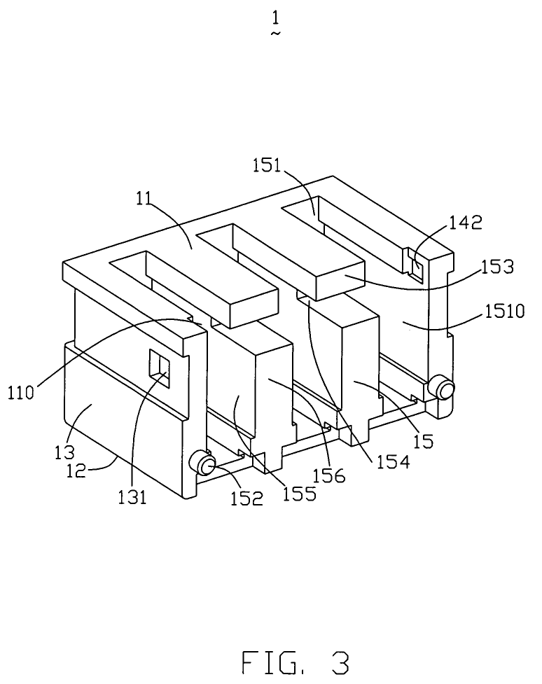

Referring to the FIG. 2 and FIG. 3, the insulative housing is rectangular and including a top wall 11, a bottom wall 12 which is opposite to the top wall 11, a left sidewall 13 which is vertical to the top wall 11 and the bottom wall 12, a right sidewall 14 which is opposite to the left sidewall 13, a front wall 15 which is vertical to the top wall 11 and the bottom wall 12, a back wall 16 which is opposite to the front wall 15. A plurality of passageways 151 extending from the front wall 15 to the back wall 16, the said passageways 151 runing through the top wall 11 of the insulative housing 1, each passageway 151 having an inner surface 1510, the concave portion 132 and 142 are set on the said inner surface 1510, a sunken portion 161 is widthwise formed in the back wall 16. The sunken portion 161 having an open slot 131 and an open slot 141 on the two sides which is near the front wall 15. The passageways 151 are separated by block wall 155, the said block wall 155 sunken and form a retention slot 154 which having a connection with the passageways 151, the said block wall 155 is separated into a upper part 153 and a lower part 156, the said upper part 153 and the lower part 156 are ladder-shape. The said front wall 15 have support pillar 152 on two sides.

Referring to the FIG. 1 and FIG. 2, the contact 2 is S-shape after a series of bending, each contact 2 including a fix portion 21, a tail portion 22 bending from one end of the retention 2, a connect portion 23 bending from the other end of the retention 2, a spring portion 24 which bending and extending from the connect portion 23, and a contact portion 25 which is set on the end of the spring portion 24. The fix portion 21 having a plurality of agnail 211 on the two sides, all the agnail can be used for supporting the contacts 2 in the insulative housing 1. The said contact portion 25 having a dummy club 251, the dummy club 251 could prevent the free end of the contact 2 from protruding from the insulative housing 1.

The metal cover 3 is made of sheet metal, including a main portion 31 and side wings 32 extending from the transverse two ends of the main portion 32, wherein a rectangular protruding portion 311 extending from the middle part's one side of the main portion 31, and the side wing 32 having retention sheet 321 which is corresponding to the open slot 131 and open slot 141.

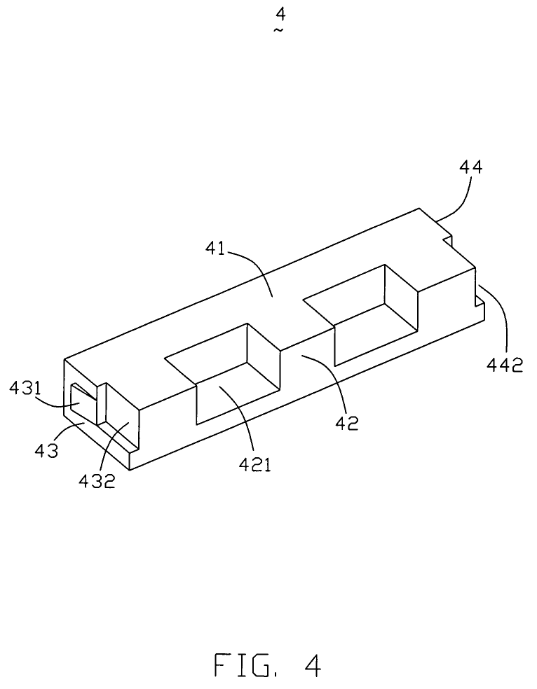

Referring to the FIG. 4, the block portion 4 including an upper surface 41, a front surface 42 which is vertical to the upper surface 41, a left surface 43 and a right surface 44, the said front surface 42 sunken and forming a sunken slot 421, the sunken slot 421 having a connection with the upper surface 41, the said left surface 43 and the right surface 44 having a wedge-shaped block 431 and 441 respectively, and the left surface 43 and the right surface 44 also sunken and form a sunken space 432 and a sunken space 442 which is corresponding to the inner surface 1510 of the passageway 151 respectively.

In the process of assembling, the contact 2 tabling the insulative housing 1 from forth to back of the front wall 15, the contact portion 25 protrude from the top wall 11 of the insulative housing 1, the dummy club 251 restricting the height which the contact portion 25 protruding from the top wall 11. The fix portion 21 is set in the insulative housing 1 through the agnail 211, the tail portion 22 protruding from the bottom of the front wall 15 and contact with the print circuit board. Afterwards, assemble the metal cover 3 with the insulative housing 1, the protruding portion 311 assemble the insulative housing 1 together closely, the retention sheet 321 coordinating with the open slot 131 and the open slot 141. The block portion 4 connecting with the insulative housing 1, the sunken slot 421 cooperating with the retention slot 154.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What we claim is:

1. A battery connector comprising:
an insulative housing;
a plurality of passageways; and
a plurality of contacts received in the corresponding passageways, respectively; wherein
the battery connector further includes a block portion to prevent the contacts from dropping out of the passageways.

2. The battery connector of claim 1, wherein the insulative housing having sidewalls on the two sides, each sidewall having a retention slot.

3. The battery connector of claim 2, wherein the two sides of the block portion having wedge-shaped blocks which is stopped in the retention slot.

4. The battery connector of claim 3, wherein the contact including a fix portion, a tail portion which extending from one end of the fix portion, and a connect portion which bending and extending from the other end of the fix portion, the end of the said connect portion having a contact portion.

5. The battery connector of claim 4, wherein the free end of the contact portion having a dummy club which is attached to the insulative housing.

6. The battery connector of claim 1, wherein the battery connector having a metal cover which is attached to the insulative housing, the said metal cover having side wings, the side wings having retention sheet.

7. A battery connector comprising:
an insulative housing;
a plurality of passageways;
a plurality of contacts configured to be assembled into the corresponding passageways in a horizontal direction, respectively; wherein
the battery connector further including a block portion assembled to the housing after the contacts have been assembled into the passageways, to limit the contacts to move only in a vertical direction perpendicular to said horizontal direction when said contacts are pressed by a counter electronic component.

8. The battery connector as claimed in claim 7, wherein the block portion is configured to be assembled to the housing in said horizontal direction.

9. The battery connector as claimed in claim 7, wherein each of said contacts includes two opposite sides respectively engaged with the housing and the block portion so as to assure movement in the vertical direction.
